(19) United States
(12) Patent Application Publication
(10) Pub. No.: US 2010/0115601 A1
(43) Pub. Date: May 6, 2010

(54) Method and an apparatus for assessing a security of a component and a corresponding system

(75) Inventors: Thomas Brandstetter, München (DE); Konstantin Knorr, München (DE); Ute Rosenbaum, Kempten (DE)

Correspondence Address: King & Spalding LLP, 401 Congress Avenue, Suite 3200, Austin, TX, 78701, US

(73) Assignee: Siemens Aktiengesellschaft, Muenchen (DE)

(21) Appl. No.: 12/413,344

(22) Filed: Mar. 27, 2009

(30) Foreign Application Priority Data
Oct. 30, 2008 (EP) EP08018995

(51) Int. Cl. G06F 17/00; G06F 11/00

(52) U.S. Cl. 726/11; 726/25

(57) ABSTRACT

In a method and an apparatus for assessing of security of components, in particular, of components involved in safety-critical infrastructures, the assessment of security of the safety-critical component has an assessing of risks of the respective component and deriving of security measures for the component. Further, an assessing of a level of implementation for each standardized security measure is performed defined by a standard and/or requirement document for the component as well as evaluating of a resilience of the component against attacks directed to the component by performing test attacks against the component which are arranged by use of test cases defined by use of risk assessing results, and by use of implementation level assessing results for each standardized security measure. Thus, improved assessing of the security of components is enabled which can be used, e.g., for insurance of the security of safety-critical components and infrastructures.

### CROSS-REFERENCE TO RELATED APPLICATIONS

This application claims priority to European Patent Application No. EP08018995, filed Oct. 30, 2008. The complete disclosure of the above-identified application is hereby fully incorporated herein by reference.

### TECHNICAL FIELD

The present invention refers to a method and an apparatus for assessing of the security of components, in particular, of safety-critical infrastructure components of an infrastructure. The present invention concerns a method for assessing the security of a component, a computer program product being configured for implementing and/or performing said method, a data carrier comprising said computer program, and a system as well as an apparatus both configured for assessing the security of a safety-critical infrastructure component.

### BACKGROUND

Protection of safety-critical infrastructures, systems, arrangements and/or apparatus employed in several technical and/or industrial areas like energy generation and distribution, telecommunication, production and/or traffic, for example, against cyber attacks is nowadays a major challenge. Such cyber attacks are unpredictable and can be directed to one or several components of the corresponding safety-critical infrastructures, systems, arrangements and/or apparatus. Cyber attacks lead to an erroneous behaviour of the corresponding components and, thus, of the whole infrastructure, system, arrangement and/or apparatus. Cyber attacks are directed to inhibiting a secure operation or security of a safety-critical component within an infrastructure, system, arrangement and/or apparatus. In the worst case, the corresponding safety-critical component and/or the infrastructure, system, arrangement and/or apparatus can break down.

Provision of security or ensuring a secure operating of safety-critical components and infrastructures, systems, arrangements and/or apparatus, in which the components are involved, is a complex and multilayered issue for several reasons. For example, several targets for attacks to a component are possible in the safety-critical infrastructure, system, arrangement and/or apparatus comprising the respective component. These targets can comprise several functionalities, processes, dependencies, relations, parts, modules, and/or sub-components of the component. Further, environments, i.e. safety-critical infrastructures, systems, arrangements and/or apparatus, in which the components are involved, have often a very complex structure.

For manufacturers of the components, in particular, of safety-critical infrastructure components, and/or of safety-critical infrastructures, systems, arrangements and/or apparatus it is important to be aware and to ensure that their products or components operate in a secure way and are robust and resistant (at least to a certain degree), with regard to cyber attacks or any attacks performed via a data network. However, often the necessary structured foundation is missing for a manufacturer to assess the current security level of a system or component. In the following, the terms safety-critical infrastructure are used as the common term for safety-critical infrastructure, critical system, critical arrangement and/or critical apparatus.

Manufacturers of safety-critical infrastructure components (CIC) such as control centres for energy generation or distribution, for example, are facing increasing security demands for their products and components from customers and regulatory bodies. The central questions to be answered by a manufacture are: How good is my product or component concerning security requirements and how secure is it in a real-world operation? The fundamental dilemma here is that the manufacturer is not operating its products or components and that an operational CIC typically consists, besides the base product, of additional components like networks, the corresponding processes and is operated by staff, which is often unaware of information technology (IT) security issues. Therefore a manufacturer of a critical infrastructure component CIC is interested in an efficient method to assess and subsequently improve the security level of its products and components extrapolating the operational challenges.

There are differences between security assessments of CIC and the “classical” office environment. Though Cyber and IT security are commonly used interchangeably, they have different underlying approaches.

The term IT security is established in and for typical office IT. The present invention, in turn, refers to CIC systems with utmost crucial functions. Besides the terminology, there are also several significant technical deviations. In IT security, to protect an entity, e.g., a component or an operating system, it is common to shut the entity down to subsequently perform analysis of the situation and to restore the usual and desired state in the corresponding system or environment. In contrast, critical infrastructure components CIC have to maintain operation and to run at all costs because of their safety-critical character in the infrastructure in which they are involved and because of the need of maintain a secure state of the respective infrastructure.

The present invention is directed to a cyber security assessment methodology (SAM), which can be used during the development of CICs. The SAM is a best effort based, pragmatic, efficient, generic, flexible, and built on CIC industry standards.

Over the last years, a rapid and partly uncoordinated growth of cyber security publications can be observed. Thus, for example, both of the following sources CSSP (Standards & References Web Site of the Control System Security Program of the US CERT, currently available at http://www.us-cert.gov/control_systems/csstandards.html) and NSDB (National SCADA Test Bed, A Summary of Control System, Security Standards Activities in the Energy Sector, October 2005, currently available at http://www.inl.gov/scada/publications/d/a_summary_of_control_system_security_standards_activities_in_the_energy_sector.pdf) easily list more than 50 standards, guidelines, and regulations concerning security of several industrial systems, components, and/or infrastructures. To keep an overview with regard to the cyber security publications, it is important for a manufacturer of CIC to organize the publications according to at least one of the following categories or main questions:
Who is the author? Industry bodies, customers/operators of CIC, regulatory bodies, laws, international standardization bodies;
Technical publications vs. management;
Industry specific vs. General IT security standards; and/or
Is the publication focusing on the development or operation of the system?

For example, the NERC CIP standard (North American Electric Reliability Council: Critical Infrastructure Protection (CIP), currently available at http://www.nerc.com/) is being published by an industry regulatory body, is rather management oriented. It is specific for the energy sector and focuses on the operation of CICs. Contrary, the procurement language (Idaho National Laboratory, Cyber Security Procurement Language for Control Systems, currently available at http://www.msisac.org/scada/, February 2008, Version 1.8.) being published by a US information sharing centre is rather technical and industry independent. It focuses on the development of CICs. For an efficient and market-oriented SAM, a manufacturer must take current standardization and cyber security publications into account to determine subsequent SAM elements that suffice state-of-the-art cyber security requirements.

### SUMMARY

According to various embodiments, security assessments of safety-critical components and, thus, also of safety-critical infrastructures, systems, arrangements and/or apparatus can be improved.

According to an embodiment, a method for assessing a security of a component, may comprise the steps of:—assessing risks of the component and deriving security measures for the component;—assessing a level of implementation for each security measure, which is defined by at least one of a standard and a requirement document for the component; and—evaluating a resilience of the component against attacks directed to the component by performing test attacks against the component, the test attacks being arranged by use of test cases and by use of implementation level assessing results.

According to another embodiment, a computer program product comprising a computer readable medium storing computer executable program code which when executed on a computer may perform the steps of:—assessing risks of the component and deriving security measures for the component;—assessing a level of implementation for each security measure, which is defined by at least one of a standard and a requirement document for the component; and—evaluating a resilience of the component against attacks directed to the component by performing test attacks against the component, the test attacks being arranged by use of test cases and by use of implementation level assessing results.

According to yet another embodiment, a system operable to assess a security of a component, may comprise a risk assessment module, the risk assessment module being configured for assessing of risks of the component and deriving of security measures for the component; a first assessment module, the first assessment module being configured for assessing a level of implementation for each security measure, which is defined by at least one of a standard and a requirement document for the component; and a second assessment module, the second assessment module being configured for evaluating a resilience of the component against attacks directed to the component by performing test attacks against the component, the test attacks being arranged by use of test cases and by use of implementation level assessing results.

According to yet another embodiment, an apparatus for assessing a security of a component within an infrastructure, may comprise means for assessing risks of the component and deriving security measures for the component; means for assessing of a level of implementation for each security measure, which is defined by a standard and/or requirement document for the component; and means for evaluating a resilience of the component against attacks directed to the component by performing test attacks against the component, the test attacks being arranged by use of test cases and by use of implementation level assessing results.

According to a further embodiment, the test cases can be based on risk assessing results. According to a further embodiment, the implementation level assessing results can be obtained by assessing a level of implementation for each security measure. According to a further embodiment, the assessing of risks comprises an identification of threats which arise with regard to the component, and evaluating of the threats, wherein for each threat a likelihood and an impact of the corresponding threat may be determined. According to a further embodiment, the assessing of risks may comprise a calculating of the risks by use of the threats identified and evaluated in the identification and evaluating step. According to a further embodiment, the level of implementation can be assessed by use of requirements defined in the standard and/or requirement document for implementation of corresponding security measure, for which the level of implementation is assessed. According to a further embodiment, the step of assessing of a level of implementation may comprise:—generating of a questionnaire comprising at least one question for each of the requirements;—evaluating of replies provided to the at least one question by mapping the replies to a value within a predefined range; and—calculating of the level of implementation by use of the mapped value. According to a further embodiment, the step of evaluating the resilience of the component against attacks may comprise:—collecting and categorizing of the test cases by use of risk assessing results, obtained by assessing of risks, and by use of implementation level assessing results, obtained by assessing a level of implementation for each standardized security measure;—retrieving information on targets of the test cases;—analyzing of threats arising with regard to the targets of the test cases and determining of risks of the threats; and—performing of the test cases, wherein with each of the test cases targets of the test cases are accessed.

### BRIEF DESCRIPTION OF THE DRAWINGS

The present invention will be understood more clearly from the following description of the preferred embodiments of the invention read in conjunction with the attached drawings, in which:

FIG. 1 shows a critical infrastructure comprising a critical component, with regard to which the security assessment methodology can be performed according to an embodiment;

FIG. 2 shows a diagram representing phases of the security assessment method according to an embodiment;

FIG. 3 shows a diagram representing processes and phases of risk analysis or risk assessment according to an embodiment;

FIG. 4 shows a diagram representing processes and phases of a theoretical assessment according to an embodiment;

FIG. 5 shows results achieved by a theoretical assessment performed according to an embodiment;

FIG. 6 shows phases, processes, or steps of a practical assessment according to an embodiment;

FIG. 7 shows an example of a sample security assessment plan provided in a practical assessment phase according to an embodiment;

FIG. 8 shows an extract of an exemplary provided report of a reporting step of the practical assessment phase performed according to an embodiment; and

FIG. 9 shows an apparatus and a system for assessing of security of a component according to an embodiment.

### DETAILED DESCRIPTION

As stated above according to various embodiments, a method for assessing of security of a (safety-critical) component, may comprise:
assessing risks of said component and deriving of security measures for said component;
assessing a level of implementation for each standardized security measure, which is defined by a standard and/or requirement document for said component; and
evaluating of a resilience of said component against attacks directed to said component by performing test attacks against said component, said test attacks being arranged by use of test cases and by use of implementation level assessing results.

In this way, the various embodiments allow measuring and quantification of a security level of a (critical) component or CIC and provides an excellent input for subsequent security decisions, e.g., for decisions on security requirements for future CIC versions (e.g., improving, adding, or changing of certain functionalities, sub-components, dependencies and/or relations of the component or with regard to the component).

By use of the various embodiments, a comprehensive, effective, and fast assessment of security of a component or CIC becomes possible. In particular, several aspects are used for assessment of the security of the component or CIC according to the various embodiments. First, risks and security measures like threats, which can arise with regard to the safety-critical component or CIC, with corresponding likelihoods and impacts, for example, concerning the component or CIC as actually developed and manufactured and as intended to be used in a critical infrastructure, system, arrangement and/or apparatus are determined and assessed. Additionally, also standardized security measures defined in standard and/or requirement documents with regard to the component or CIC and their level of implementation within or with regard to the component or CIC are identified and evaluated. Moreover, test attacks arranged based on the risks and security measures identified with regard to the component or CIC and based on the standardized security measures and their implementation levels with regard to the component or CIC are performed to determine the actual level of implementation of security requirements and the actual resistance of the component or CIC against attacks.

Moreover, the various embodiments allow a flexible and generic way of assessment of security of safety-critical components or CICs and enables assessing of several components or CICs of several critical infrastructures, critical systems, critical arrangements and/or critical apparatus by considering several standard or general requirement documents.

According to an embodiment, said assessing of risks comprises identification of threats, which can arise with regard to said safety-critical component or CIC, and evaluating of said threats, wherein for each threat a likelihood and an impact of the corresponding threat is determined.

According to a further embodiment, said assessing of risks comprises calculating of said risks by use of said threats identified and evaluated in said identification and evaluating step.

Thus, a comprehensive consideration of the safety-critical component or CIC, its relations, functions, and/or sub-components and its environment is performed when assessing of security of the component or CIC.

According to an embodiment, said level of implementation is assessed by use of requirements defined in said standard and/or requirement document for implementation of corresponding security measure, for which said level of implementation is assessed. Thus, requirements set in general to the security of the safety-critical component or CIC are taken into account by the various embodiments when assessing the security of the component or CIC.

According to a further embodiment, said assessing of a level of implementation comprises:
generating of a questionnaire comprising at least one question for each of said requirements;
evaluating of responses provided to said at least one question by mapping said responses to a value of a predefined range; and
calculating of said level of implementation by use of said value of a predefined range.

In this way, a broad insight into the security level of the safety-critical component or CIC is enabled and taken into account for assessing of the security of the component or CIC.

According to an embodiment, said evaluating of resilience of said safety-critical component CIC against attacks comprises:
collecting and categorizing of said test cases by use of risk assessing results, obtained by assessing of risks, and by use of implementation level assessing results, obtained by assessing a level of implementation for each standardized security measure;
retrieving information on targets of said test cases;
analyzing of threats arising with regard to said targets of said test cases and determining of risks of said threats; and
performing of said test cases, wherein with each of said test cases targets of said test cases are accessed.

Here, the targets of the test cases represent targets, which can be aimed at by cyber attacks with regard to the safety-critical component or CIC and which refer, for example, to operating, functionalities, processes, parts, sub-compounds, relations, environment, and/or dependencies of the component or CIC. These targets can be derived, in particular, by use of results of the assessing of risks of the component or CIC. Further, the targets of the test cases can be defined by requirements set to the component or CIC in standard or general requirement documents. In particular, these targets can be determined by use of the implementation level assessing results.

Thus, a comprehensive practical testing of actual robustness of the component or CIC is enabled.

According to yet another embodiment, a computer program product may comprise a code, the code being configured to implement and/or perform the method introduced above and explained below in more detail.

According to an embodiment, the code is stored on a data carrier.

According to a further embodiment, the computer program product is configured to perform said method when the computer program product is executed by a processing unit like a processor, for example.

According to yet another embodiment a data carrier may comprise said computer program product.

According to yet another embodiment, an assessment system may be configured for assessing of a security of a safety-critical component or CIC, and said assessment system comprising:
a risk assessment module, said risk assessment module being configured for assessing of risks of said component or CIC and deriving of security measures for said component or CIC;
a first (theoretical) assessment module, said first assessment module being configured for assessing of a level of implementation for each standardized security measure, which is defined by a standard and/or requirement document for said component or CIC; and
a second (practical) assessment module, said second assessment module being configured for evaluating of a resilience of said component or CIC against attacks directed to said component or CIC by performing test attacks against said component or CIC, said test attacks being arranged by use of test cases defined by use of risk assessing results which can be obtained by assessing of risks, and by use of implementation level assessing results which can be obtained by assessing a level of implementation for each standardized security measure.

Moreover, according to yet another embodiment, an assessment apparatus may be configured for assessing a security of a at least one (critical) component or CIC and comprising an assessment system as introduced above. Thus, the assessment apparatus is arranged such that it comprises the modules of the assessment system as introduced above and described in more detail below, in particular: a risk assessment module, a first (theoretical) assessment module, and a second (practical) assessment module.

Here, it has to be noted that both the assessment system and the assessment apparatus can perform also further functionalities and are not restricted only to the assessment function.

Thus, the various embodiments enable a comprehensive, effective, fast, and generic method for assessing of the security of safety-critical components or CICs exploited or to be exploited in safety-critical infrastructures, systems, arrangements and/or apparatus employed in several technical and/or industrial areas.

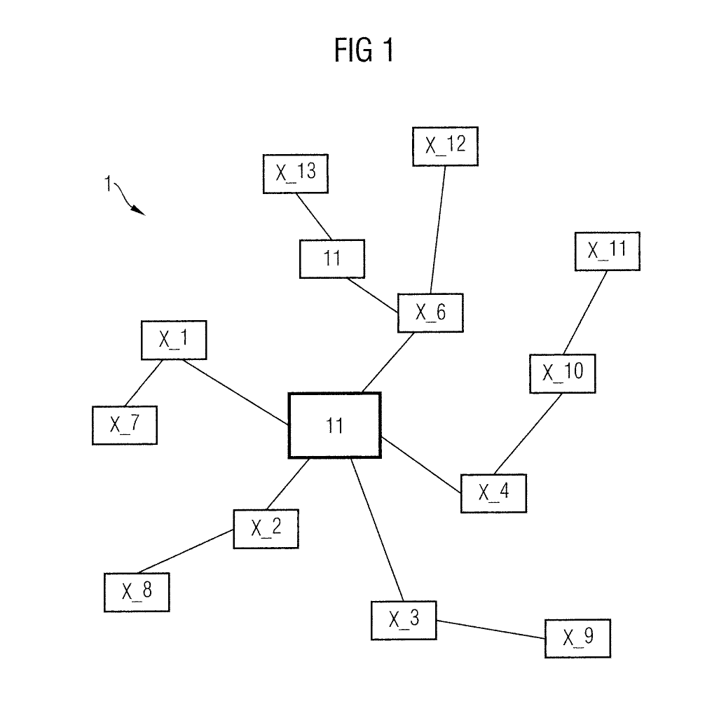

FIG. 1 shows a infrastructure 1 for energy generation and distribution, telecommunication, production, or traffic, for example, comprising at least one critical component 11 with regard to which the security assessment method can be performed according to an embodiment. The critical component or CIC 11 is a component, which is provided for a secure operation of the respective infrastructure 1 and which can be a target for cyber attacks. The CIC 11 can be, for example, a control centre configured for performing control and/or management functions in a system, infrastructure, or component. The CIC 11 can for instance be a component responsible for energy generation or distribution or for controlling other components in a telecommunications system. Here, several elements, modules, (sub-) systems, units etc. can represent the CIC 11. Further, a CIC 11 is not restricted only to provide a control function, but can also be responsible for several tasks or functions, secure performing of which is important in the respective infrastructure 1.

According to the embodiment shown in FIG. 1, the CIC 11 has several connections or relations to further components, modules, and/or sub-systems X_1 to X_13 in the infrastructure 1. From the example of FIG. 1, it becomes apparent that it is to ensure a correct and secure operation of the CIC 11 in the infrastructure 1 is important. An error in the shown CIC 11 or a break down of the CIC 11 leads to errors within the further entities X_1 to X_13 of the infrastructure 1. In the worst case, the other entities X_1 to X_13 can break down as well.

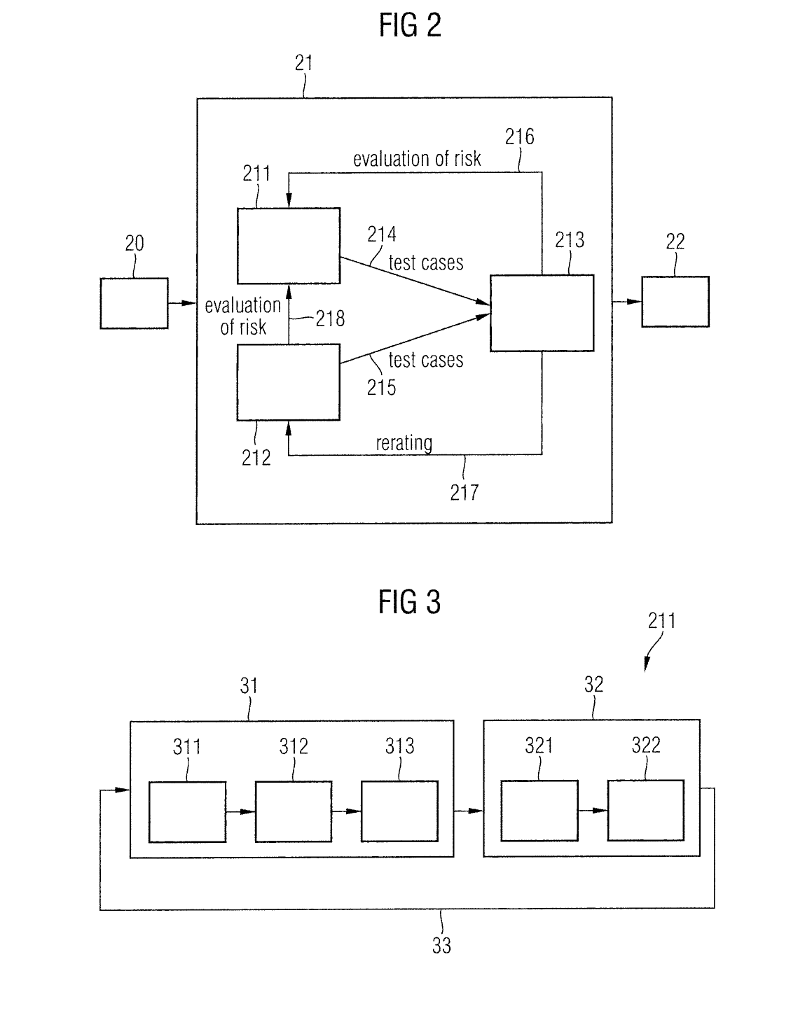

FIG. 2 shows a diagram representing phases, modules, or components 211, 212, 213 of the security assessment method 21 according to an embodiment. Additionally, relations between the different phases, modules, or components 211, 212, 213 used for performing the security assessment method 21 according to the present embodiment are represented in FIG. 2.

The security assessment method 21 can be applied with regard to the CIC 11 of the infrastructure 1 shown in FIG. 1.

In general, FIG. 2 provides a high level overview of the individual phases, modules, or components 211, 212, 213 of the security assessment method 21:

At first, pre-assessment activities can be performed in phase, module, or component 211 before performing the security assessment method 21. The pre-assessment activities can include to get a written consent for the security assessment method 21.

The security assessment method 21 comprises in general three phases, modules, or components: Risk Assessment 211 (RA), a first (theoretical) Assessment 212 (TA), and a second (practical) Assessment 213 (PA).

The RA 211 determines the individual risk level of the CIC and subsequently derives specific security measures for the CIC.

The TA 212 assesses in how far security measures, which are based on a standard (e.g., Idaho National Laboratory, Cyber Security Procurement Language for Control Systems, currently available at http://www.msisac.org/scada/, February 2008, Version 1.8.), are implemented for the respective CIC. This typically includes technical, organizational and process aspects. Subsequently security measures specific for the underlying standard document but unspecific for the CIC are derived.

During the PA 213 practical tests—manually and/or with hacker tools—are done in a suitable test environment. In this way, the actual exploitability of the CIC can be proven.

When phases 211, 212, 213 or activities or the modules or components 211, 212, 213 of the security assessment method 21 have been performed and finished, post assessment activities can be performed by phase, module, or component 22. Such post assessment activities 22 can include, for example, the communication of the findings, final reporting, issuing of a SAM confirmation, help with fixing and track fixing of security holes, and/or help in defining requirements for future product releases.

The arrows shown in FIG. 2 between the phases, modules, or components 211, 212, 213 of the security assessment methodology 21 indicate relations between the phases, modules, or components RA 211, TA 212, and PA 213.

The arrow 214 shown in FIG. 2 leading from RA 211 to PA 213 indicates that the results of the RA 211 define test cases for performing and/or implementing of the PA 213. The arrow 215 leading from TA 212 to PA 213 indicates that the results of the TA 212 define test cases for performing and/or implementing of the PA 213.

When a practical assessment PA 213 has been performed, results of the PA 213 can be used for evaluation of risks assessed in the risk assessment RA 211. Here, the individual risk levels determined by the RA 211 can be evaluated and, if necessary, corrected. This relation between PA 213 and the RA 211 is indicated by an arrow 216.

Further, results of PA 213 can be used also for re-rating of the results of TA 212. Here, values or levels indicating how far security measures based on a standard are implemented for the CIC, which have been determined within the scope of TA 212, can be corrected by considering results achieved after performing attacks on the CIC by PA 213. This relation between the PA 213 and the TA 212 is indicated by an arrow 217.

Additionally, results of TA 212 can influence RA 211. In particular, the risks determined by the RA 211 can be evaluated by considering results of TA 212 and/or by considering requirements set to the CIC by standard and/or requirement documents used in the TA 212. Thus, the risks determined by RA 211 can be brought in conformity with standardized requirements and can be assessed in a way, which is in line with predefined standards and general requirements. This relation between the TA 212 and the RA 211 is indicated by an arrow 218 in FIG. 2.

FIG. 3 shows a diagram representing processes and phases of risk analysis, risk assessment, or RA 211 according to an embodiment.

The shown exemplary embodiment is based on the following standard document ISO/IEC TR 13335-3:1998(E) and on NIST's “Risk Management Guide for Information Technology Systems” (NIST SP 800-30, currently provided at http://csrc.nist.gov/publications/nistpubs/800-30/sp800-30.pdf). As with all other phases of the security assessment method 21, security efforts are balanced with efficiency and economical aspects. Therefore, the risk assessment 211 can be conducted in the form of group workshops which can last depending on the complexity of the respective CIC. By relying on a broad spectrum of participants from different domains like product development, system test, service, sales and marketing, product management, and/or engaging, for example, in a workshop/round table discussion accompanied by introductory telephone interviews of participants, the know-how existing in the staff of a CIC manufacturer can be used in. As a product usually is not developed from scratch, these participants have comprehensive experience and knowledge that can be recycled and used to create an efficient risk assessment process in terms of a highly valuable outcome within a rather short period of time. This process can be guided, for example, by an experienced assessor, who advantageously has both the capability to act as a security expert and the capability to act as a moderator.

The goal of this process is to efficiently determine the adequate risks for a concrete CIC or CIC system. The output of this step 211 represents a valuable input for the later practical assessment stage or phase 213 when determining attack goals.

The TA 211 provided in the present embodiment comprises two processes or phases: a threat analysis 31 and a risk analysis 32.

During the threat analysis 31, a system inventory 311 is performed, wherein components and relations between these components within the system are identified, listed, and specified. Then, a threat identification 312 is performed by analyzing the components and relations of the system identified and specified in the system inventory phase or step 311. In particular, weak and attackable components and relations, impacts of possible attacks and/or errors for the system and for the security of the system are identified. Further, in step or phase 313, a threat evaluation is performed with regard to the threats identified in the step or phase 312. Here, for each threat, likelihood and impacts of the respective threat are determined.

During the risk analysis 32, an impact evaluation 321 is performed, wherein impacts identified for threats in the threat analysis phase or process 31 are analyzed. Then, in step 322 a risk calculation is performed, wherein individual risk levels are determined.

According to the present embodiment, the output of a risk analysis 32 comprises:
a list of critical assets, wherein this list can be used as a basis for performing of the PA 113; and
a list of threats, wherein to each of the threats a corresponding likelihood for the threat and impacts are specified and stored.

After completing of the risk analysis step or phase 32, anew threat analysis and subsequent anew risk analysis can be performed to monitor (start from beginning) and control the results obtained. This is indicated in FIG. 2 by the arrow 33.

As already mentioned above, the evaluation 216 of risks being specified and assessed by the RA 211 can be performed after performing of the PA 213. Within this scope, due to practical findings, further risks can be added and/or the likelihoods and/or the impacts of the threats determined and specified previously in the RA 211 can be adjusted.

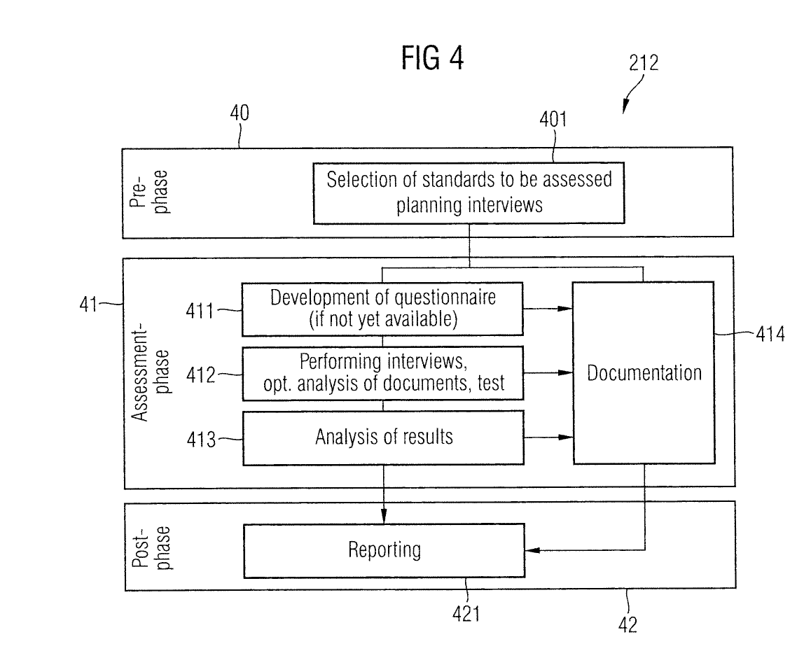

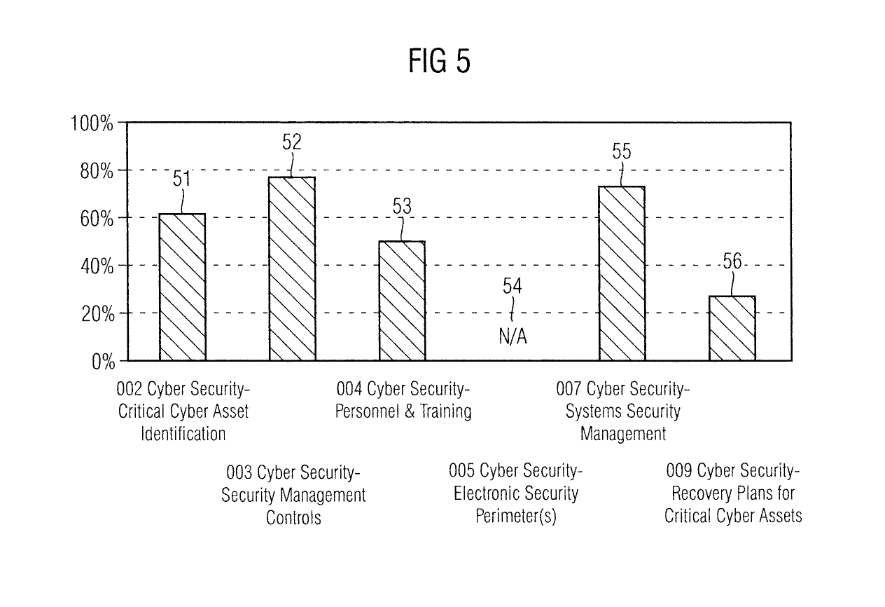

FIG. 4 shows a diagram representing processes and phases of a theoretical assessment or TA 212 according to an embodiment.

For critical infrastructure systems private and public operators and regulators have perceived in the last years that security needs to be integrated into products and systems and that a common approach should ensure that enough security is realized within these products and systems. Therefore, standards and requirement documents have been developed and published in the last years such as e.g. those mentioned above. The standards and requirement documents define requirements for ensuring that enough security is provided within products and/or systems to which the standards and the requirement documents are directed.

For product management this is a challenge and an opportunity. The right standards have to be selected and the respective level of implementation is to be assessed. Based on the results, further implementation steps are decided. A common requirement paper from prospective customers instead of many diverging single requirements can be used.

With regard to FIG. 4 and within the scope or TA 212, a method for assessing a level of implementation with regard to generic requirement documents is presented. The method can be applied by use of different standards for several products or components.

The principle of this assessment approach is to interview relevant persons based on a questionnaire to guide through the interviews and to document and evaluate their replies. Depending on the required assurance or security level, in addition to the interviews, the documentation is checked or the system itself is tested.

As shown in FIG. 4, before starting the actual assessment phase 41 within the TA 212, a pre-phase 40 can be performed, which comprises as step 401. The selection of standards to be assessed and the planning of interviews. At first, the standard documents or general requirement documents relevant for the critical component(s) to be assessed are identified. Then, it is planned which interviews with regard to which standard have to be performed for the TA 212. Here, experts having knowledge with regard to contents of the standards are identified and corresponding meetings are organized.

For each standard to be assessed, the requirements for the manufacturer need to be derived. Depending on the target group of the standard, the requirements can be either applied directly or deducted in an intermediate step.

As an example, in the following the aforementioned NERC CIP standard is considered and applied to operators of Bulk Electric Systems. When performing a security assessment of critical components or CICs, one important task or step for product manufacturers represents the deriving of requirements from predetermined standard documents or general requirement documents respectively. The requirements comprised in such documents cover not only technical aspects, but also documentation requirements and organizational processes that are carried out by different departments—development, project groups, and support. For manufacturers, it is important to be aware that their products meet the requirements set out be the standard documents or general requirement documents respectively. However, also when sounding as being simple, in practice, this task or step is a challenging and difficult process.

In following, the difficulty for deriving requirements from standard documents is illustrated by use or the NERC CIP as one example for a predefined standard comprising the requirements for the critical components to be assessed.

The NERC CIP requires that the operator maintains logs of system events related to cyber security for 90 calendar days, and reviews these logs. Just asking if the product supports logging is not sufficient as most systems do support a basic form of logging already. Here, conventional logging technologies can be used. Typical features are, for example, a possibility for central storage and comprehensible logging data that is stored for at least 90 days and protected against tampering. Also the review of the data must be facilitated.

In contrast to NERC CIP, the German White Paper “Requirements for Secure Control and Telecommunication Systems” (Bundesverband der Energie-und Wasserwirtschaft: White Paper Requirements for Se-cure Control and Telecommunication Systems, Berlin, June 2008, currently available at http://www.bdew.de/bdew.nsf/id/A975B8333599F9B0C12574B400348E7A/$file/Whitepaper_Secure_Systems_Vedis_{—}1.0final.pdf) as well as the US “Cyber Security Procurement Language for Control Systems” (Idaho National Laboratory. Cyber Security Procurement Language for Control Systems, currently available at http://www.msisac.org/scada/, February 2008, Version 1.8.), for example, summarize security principles that have to be considered when designing and procuring control system products and are intended for use in tenders to specify the security requirements. Therefore, both documents are well suited as direct input for an assessment of the security level of a given product. All requirements can be checked directly, but, as the scope of the document is broad, some requirements will not be applicable for a given product and, therefore, can be marked as not applicable during the assessment.

When the pre-phase is finished with regard to at least one standard document, an assessment phase 41 can be started. Within the assessment phase 41, at first, a questionnaire 411 is developed. In particular, this step 411 is performed if the questionnaire is not available or if the questionnaire is not complete. The development of a questionnaire 411 is performed with regard to each of standard or general requirement documents selected in step 401 in the pre-phase 40.

Thus, for the assessments, a questionnaire per standard is used. The goal of the questionnaire is to provide a tool to make the degree of compliance of the critical component(s) or CIC(s) with requirements defined in the standard or general requirement documents measurable and to yield comparable results independent from the interviewer and the product.

The questionnaires have a generic constitution independent of the standard, with its content structured according to the pattern of the underlying standard. For each requirement one or more corresponding questions are derived with predefined replies that can be selected, and a field where additional comments and descriptions can be inserted, to make replies comprehensible and traceable.

The challenge and the effort for deriving the questionnaire lie in the content and formulation of the questions, since questions have to be comprehensible and the replies must allow an easy benchmarking. The questionnaire itself and the functionality for evaluation of the answers or replies are generated by a corresponding software tool.

As far as possible the questions should be formulated in such a way that they can be answered with “yes”, “no”, or “Not Applicable”. By such formulations, a fast assessment of the critical component(s) or CIC(s) can be performed, without the need to use too much additional storage means.

However, a experience shows generic answers are not sufficient when a high quality of the assessment is expected. Therefore, for some requirements “intermediate” replies can be specified, if necessary. Here, as an example the reply “Dependent on contract” can be taken. It expresses the case that some requirements are not fulfilled by the standard product offering, but, depending on the contract, can be offered as additional feature. This reply can be given for instance to aspects of a service. Here, a plurality of further “intermediate” answers can be specified according to the present embodiment.

For purpose of an automatic evaluation, the replies are mapped to a value of a predefined range. These values are used to calculate an average compliance value per section and per chapter. “Not applicable” replies or answers are not used for calculating of the average compliance value.

Here, the question can arise, not to use values for answering the questions right from the beginning and give an explanation how to use the numbers. This can be done for some questionnaires and, in some cases, this will provide sufficient results. However, for the most cases, in practice, drawbacks with regard to comparability and traceability have been experienced. One reason is, for example, the fact that different interviewers can give different values to the same reply or answer, e.g., if something depends on the contract, one interviewer gives full points, as the requirement can be fulfilled; the other interviewer assignes no point because the standard offering did not fulfil the requirement. With regard to their experiences, both interviewers can have good reasons for their subjective rating. However, the results are quite different and, therefore, can not be compared. Also during one interview, for long questionnaires, a bias can occur. At beginning the rating can be more strict whereas in the end the rating can be more “gentle”. These effects are reduced by use of predefined replies. In principle, with the mapping of a possibility or probability for an reply is provided from the point of view of an interviewer.

Thus, when performing the assessment phase 41, first a development of a questionnaire is performed 411, if necessary or required. Then, in step 412, interviews with experts by use of the questionnaire can be performed, wherein optionally also an analysis of documents and tests can be performed within step 412. Subsequently, an analysis 413 of the results is performed in the assessment phase 41. Moreover, according to the present embodiment, with regard to each of the steps 411, 412, and 413 a documentation 414 of these steps 411, 412, and 413 can be performed. In the following step 412 interviews can be performed and in step 413 the results achieved in step 412 are analyzed as explained in more detail.

Based on the questionnaire, the theoretical assessment 212 can be performed within workshops of product experts answering the questions, and experienced security experts independent from product development, who are doing the interviews and guide through the questionnaire. These interviews are performed within the step 412 of the assessment phase 41 of the theoretical assessment or TA 212.

Based on the questionnaire, the theoretical assessment can be supported by extensive workshops with product experts answering questions and experienced security experts independent from product development who are doing the interviews and guide through the questionnaire. Depending on the assessment goal, different assessment depths are possible. It is possible just to document an oral statement of the interviewed person (first assessment depth). Further, it is possible to perform an additional checking or studying of the documents (assessment depth 2) or doing practical tests (assessment depth 3). The assessment depths can be varied on a per requirement or a per section base e.g. to focus on more important topics.

A basic assessment can be done on the basis of an interview with one or more experts from different domains such as product management, development, system engineering and security, if available. In case, the participants are not sure whether they all have the same understanding of the topic discussed, the documentation can be checked and/or the system can be tested.

The assessment can also seen more comprehensive than an external audit. Here, documentation of the system and the processes can be checked and additionally also system functionality can be reviewed. The scope of the checks can be decided by the respective auditor and can be limited by a (pre) defined timeframe.

The assessment depth can be varied per requirement or per section base, e.g., to focus on more important topics. In practice, a compromise can be achieved by performing spot tests for some topics and derived from the theoretical assessment topics for practical security assessments. This combination additionally assures, that all intended security mechanisms are really implemented securely, and, thus, raises the level of confidence.

Subsequently, an analysis 413 of results is performed according to the present embodiment.

Here, the method and the underlying tool give an instant overview about the level of compliance for the different sections. The result of the first (theoretical) assessment or TA 212 is the level of compliance of the critical component or CIC, being manufactured, with the requirements and the actual deviations defined by the standard or general requirement documents.

Further, the first assessment or TA 212 can comprise a post-phase 42. According to the present embodiment, the post-phase 42 comprises a reporting phase or step 420, in which results of the first assessment or TA 212 are reported and/or visualized and displayed in an appropriate way, as exemplary provided in FIG. 5.

FIG. 5 shows results achieved by a first assessment or TA 212 performed according to the present embodiment. In particular, FIG. 5 shows an overview of a compliance of a critical component or CIC with NERC CIP, taken here as an exemplary standard document. Here, the critical component or CIC to be assessed has functions for backup but no documented recovery concept.

In FIG. 5, the vertical scale indicates an exemplary degree of compliance of the CIC with NERC CIP in percentage, wherein several sub-standards or requirements 51, 52, 53, 54, 55, 56 have been considered within the first theoretical assessment or TA 212. In FIG. 5, the coverage with the following sub-standards or requirements has been considered: 002 Cyber Security, Critical Cyber Asset Identication 51; 003 Cyber security, Security Management Controls 52; 004 Cyber Security, Personnel & Training 53; 005 Cyber Security, Electronic Security Perimeter(s) 54; 007 Cyber Security, Systems Security Management 55; and 009 Cyber Security, Recovery Plans for Critical Cyber Assets 56.

It has to be noted, that different products, components, systems etc. can be assessed according to various embodiments. These products, components, systems etc. or in general CIC can be sold in different markets. Therefore, the theoretical assessment 212 or checking can be performed with regard or against several standard or general requirement documents. As some sections within different standards can cover the same or similar topic, consistency checks or theoretical assessments 212 can be performed in an easy, efficient, and effective way, in particular, as presented in the present embodiments.

In the next phase of the security assessment method 21, in the practical second assessment 213, a resilience of the critical component or CIC against practical hacking-attacks is evaluated. This step is performed in order to detect exploitable vulnerabilities and potential security flaws in a critical component or CIC, taking into account hacking know-how and hacking-tools. The results from both the RA 211 and the TA 212 are evaluated as input for actual attack patterns. This third step 213 in the security assessment method 21 complements the foregoing steps 211, 212 appropriately by verifying the actual implementation of the critical component or CIC.

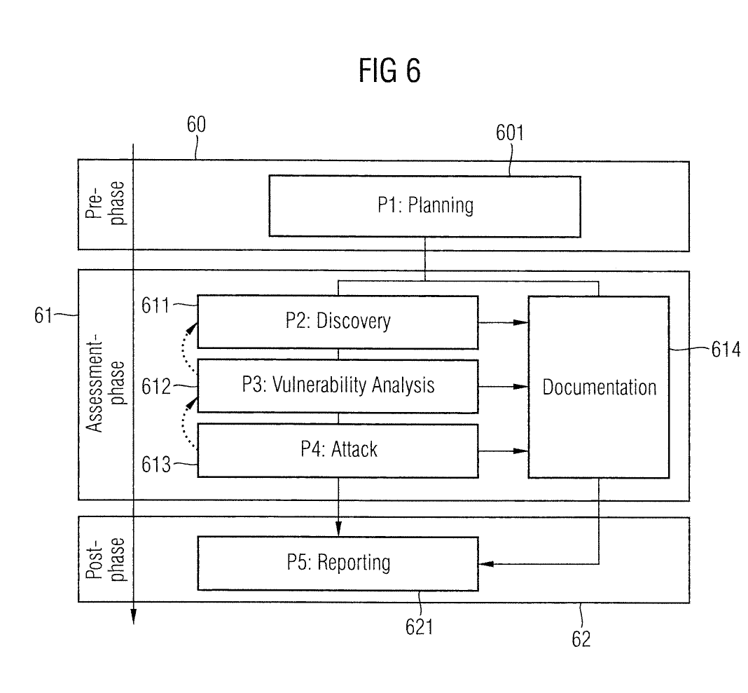

This is necessary though security requirements and design may have existed and have been applied in earlier critical component or CIC development phases, but flaws may have been introduced during actual coding phase. With the whole security assessment method 21, the PA phase 213 can be structured. In following an exemplary security assessment plan is provided for the PA 213 as shown in FIG. 6, wherein particular steps 601, 611, 612, 613, 621 of FIG. 6 are exploited for this purpose.

Thus, FIG. 6 shows phases, processes, or steps of a practical assessment or PA 213 according to an embodiment. In particular, according to the present embodiment, the PA 213 comprises three phases, i.e. a pre-phase 60, an assessment phase 61, and a post-phase 63.

With regard to pre-phase 60, according to the present embodiment, it comprises as a step or phase of planning 601 (referred in FIG. 6 also as P1) and security assessment plan development.

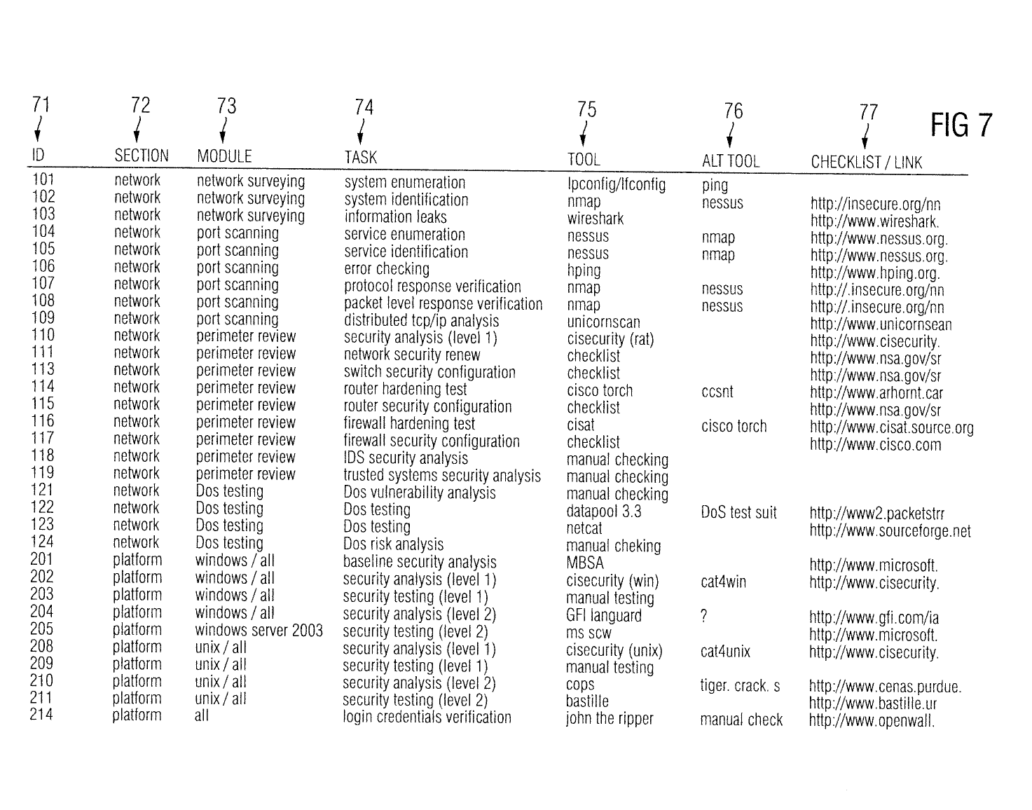

In step 601, the assessment tasks are initially collected and categorized from former steps 211 and 212 of the security assessment management 21. In general, in the pre-phase 60, an assessor can decide and evaluate the scope and depth of subsequent tasks, allowing to control the depth and intrusiveness of the assessment to its full extent. The planning phase or step 601 can be seen as one of the most crucial ones, as all subsequent test cases in terms of intrusion attempt tasks are derived from here. This is necessary in order to match and tailor the assessment tasks to the overall requirements of the critical component or CIC, where certain test methods may be unsuitable, e.g. denial-of-service tests in productive environments. The actions are then arranged according to the structure of sections, modules and tasks. FIG. 7 gives an example on this task structure in an exemplary security assessment plan.

In FIG. 7, the column 71 represents identifiers or IDs of the entries of the sample security assessment plan, column 72 provides information on sections of the infrastructure or system tested or to be tested practically, column 73 provides information on modules tested or to be tested practically, column 74 provides information on the tasks performed or to be performed by the practical testing, column 75 indicates the tools used or to be used for the practical testing, column 76 indicates alternative tools used or to be used for the practical testing, and column 77 indicates a checklist or a link to a checklist explaining the corresponding practical checking or practical attack process or to be performed within the PA 213.

Once task planning 601 is finished, the actual practical assessment-phase 61 starts, wherein a structured execution of attacks against the system and against the critical component or CA is performed. According to the present embodiment, the assessment phase 61 comprises the following sub-steps or (sub-) phases: P2 or discovery 611, P3 or vulnerability analysis 612, P4 or attack 613, and documentation 614.

According to the present embodiment, the discovery step 611 includes an information retrieval from the target and passive testing using analyzing tools and techniques. The vulnerability analysis step 612 classifies detected vulnerabilities and weaknesses. Besides a threat classification, this step requires a tester to verify a threat, to identify possible risks that are associated with each threat and to document all significant findings for later reporting. The attack step 613 involves an active testing using invasive tools and techniques, which envision to gain access to the target component or to crash a certain service or function of the component.

Typical activities here can for example comprise port and/or security scanning, service verification, account brute-forcing, utilization of commercial and/or self-developed protocol fuzzers, packet spoofing attempts, operating system and/or database hardening checks, patch level verification, denial-of-service attacks and/or web application specific attacks like cross-site-request-forgery, sql injection and/or HTTP response splitting.

Strong dependencies can exist between steps or phases 611, 612, and 613, since newly gained findings can be fed back into appropriate tasks. This fact is visualized in FIG. 6 by the dashed arrows from the phase 613 to the phase 612 and from the phase 612 to the phase 611. In this way, results achieved in a later phase 612, 613 can be used when performing a previous phase 611, 612 again to improve the results of the corresponding phase 611, 612 and, thus, of PA 213.

Additionally, according to the shown embodiment, the assessment phase 61 comprises also a documentation phase, stage, or process 614, in which each of the phases 611, 612, and 613 can be documented, wherein also the results of the phases 611, 612, and 613 can be documented by the documentation phase or process 614. The documentation process 614 can be run parallel to the phases 611, 612, and 613.

When the assessment phase 61 of the PA 213 is finished, a post-assessment phase 62 can be performed according to the present embodiment. Inputs of the post-assessment phase 62 are results and conclusions of the attacks performed in step 613 and, if available, documentation of the steps or phases 611, 612, 613 of the assessment phase 61 provided by the documentation step or phase 614.

According to the present embodiment the post-assessment phase 62 comprises a reporting phase, stage, or step 621 (referred to in FIG. 6 also as P5). By the reporting step or phase 621, a report is provided, in which all findings produced throughout the assessment phase 61 are documented and which forms the base for potential workarounds or mitigation concepts.

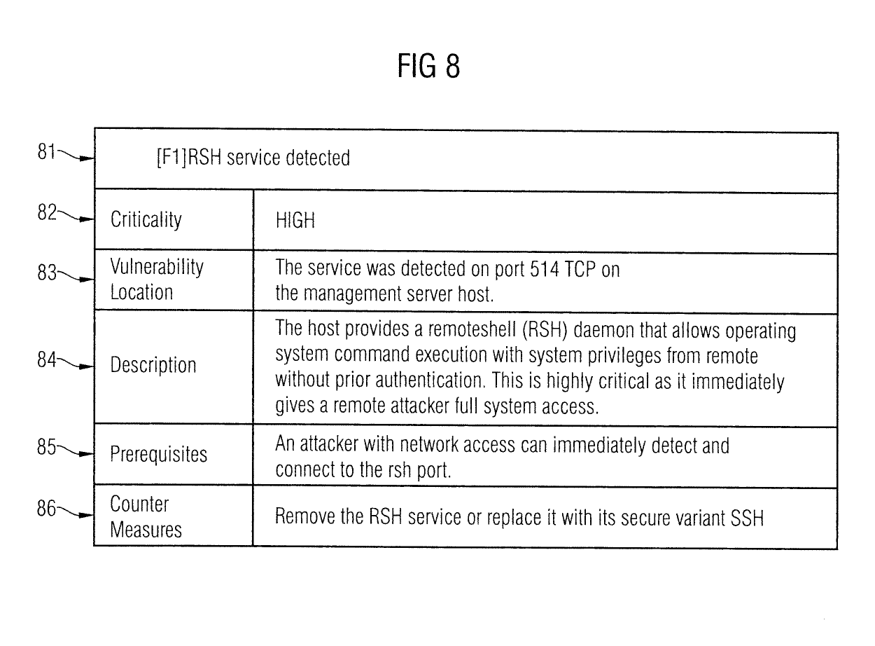

The report provided by the reporting step or phase 621 also demonstrates and ensures that all sections chosen during the planning phase or step 601 have actually been covered during the assessment phase 61. FIG. 8 shows an extract or a part of an exemplary report of the reporting phase or step 621 performed according to the present embodiment. In particular, the extract shown in FIG. 8 corresponds to a sample finding of the security assessment plan shown exemplary in FIG. 7, wherein the sample finding corresponds to assessing of a RSH service detected and is indicated by row 81 of FIG. 8. Further, row 82 or the extract of the exemplary provided report of FIG. 8 indicates a criticality of the sample finding as being “high”. Row 83 indicates vulnerability location of the sample finding and reports that the service was detected on port 514 TCP on the management server host. Row 84 indicates a description of the sample finding and reports “that the host provides a remote shell (RSH) daemon, which allows operating system command execution with system privileges from remote without prior authentication, and that this is highly critical as it immediately gives a remote attacker a full system access”. Row 85 indicates prerequisites of the sample finding and reports that “an attacker with network access can immediately detect and connect to the RSH port”. Row 86 of the table shown in FIG. 8 indicates counter measures of the sample finding and reports that they comprise “a removal of the RSH service or replacing of the RSH service with its secure variant SSH”.

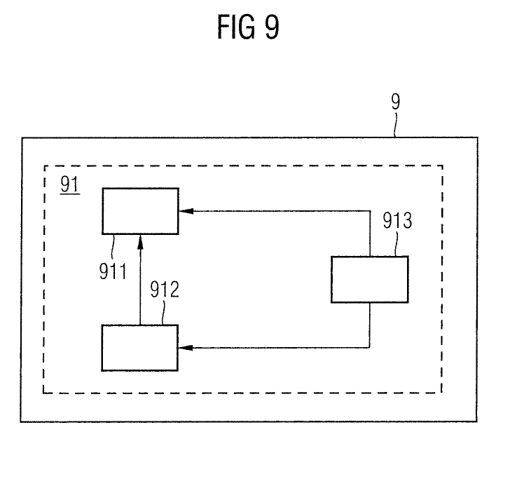

FIG. 9 shows an apparatus 9 and a system 91 for assessing security of a critical component or CIC according to an embodiment.

The system 91 is configured for assessing an operation security of a critical component or CIC and comprises a risk assessment module 911, a theoretical first assessment module 912, and a practical second assessment module 913. The risk assessment module 911 is configured for assessing risks of the safety-critical component or CIC and for deriving security measures for the critical component or CIC, as already described above. The first assessment module 912 is configured for assessing of a level of implementation for each standardized security measure, which is defined by a standard and/or requirement document for the critical component or CIC, as already described above. The second assessment module 913 is configured for evaluating the resilience of the safety-critical component or CIC against attacks directed to the critical component or CIC by performing test attacks against the critical component or CIC. The test attacks can be arranged by use of test cases defined by use of risk assessing results, obtained by assessing of risks. Further the test attacks can be arranged by use of implementation level assessing results, obtained by assessing a level of implementation for each standardized security measure, as already described above.

Further, according to the present embodiment the modules 911, 912, 913 forming a modules system or an apparatus comprise relations to each other as already described with regard to FIG. 2. These relations are indicated in FIG. 9 by arrows connecting the modules 911, 912, and 913.

Thus, according to various embodiments, a method for structured security assessments can be successfully applied during the development of several products or components for safety-critical infrastructures.

In particular, according to various embodiments, the security of a component, in particular, of a component involved in an infrastructure can be assessed. The assessing of the security of the component comprises: assessing of risks of said component and deriving of security measures for said component; assessing a level of implementation for each standardized security measure, which is defined by a standard and/or requirement document for said component; and evaluating a resilience of said component against attacks directed to said component by performing test attacks against said component, said test attacks being arranged by use of test cases defined by use of risk assessing results, obtained by assessing of risks, and by use of implementation level assessing results, obtained by assessing a level of implementation for each standardized security measure. Thus, the various embodiments enable an effective, comprehensive, and improved assessing of security of components, in particular, of critical components and can be used for insurance of security of critical components and critical infrastructures.

The security assessment method is based on experiences of security analysis of critical infrastructure components (CC) and critical infrastructure component security needs. The method can be applied to various critical infrastructure components and systems comprising critical infrastructure components. As the method according to the various embodiments is generic, it can applied to other systems as well, e.g. standard office and IT-systems. As a prerequisite a set of relevant security standards for this kind of systems needs to be identified to enable a selection of the most appropriate standards for the actual security analysis. Further, a practical assessment tool used has to be chosen in accordance with the respective application field.

When considering embodiments and applications of this invention shown and described above, it should be apparent to those skilled in the art that many more modifications (than mentioned above) are possible without departing from the inventive concept described herein. Therefore, the present invention is not restricted to the above presented embodiments only and can vary within the scope of the claims. Thus, it is intended that the foregoing detailed description should be regarded as illustrative rather than limiting and that it should be understood that the following claims include all equivalents described in these claims, which are intended to define the scope of the present invention. Further, it has to be pointed out, that the foregoing description is not intended to disavow the scope of the invention as claimed or to disavow any equivalents thereof.

What is claimed is:

1. A method for assessing a security of a component, said method comprising the steps of:
assessing risks of said component and deriving security measures for said component;
assessing a level of implementation for each security measure, which is defined by at least one of a standard and a requirement document for said component; and
evaluating a resilience of said component against attacks directed to said component by performing test attacks against said component, said test attacks being arranged by use of test cases and by use of implementation level assessing results.

2. The method according to claim 1,
wherein said test cases are based on risk assessing results.

3. The method according to claim 1,
wherein said implementation level assessing results are obtained by assessing a level of implementation for each security measure.

4. The method according to claim 1, wherein said assessing of risks comprises an identification of threats which arise with regard to said component, and evaluating of said threats, wherein for each threat a likelihood and an impact of the corresponding threat is determined.

5. The method according to claim 4,
wherein said assessing of risks comprises a calculating of said risks by use of said threats identified and evaluated in said identification and evaluating step.

6. The method according to claim 1,
wherein said level of implementation is assessed by use of requirements defined in said standard and/or requirement document for implementation of corresponding security measure, for which said level of implementation is assessed.

7. The method according to claim 6, wherein the step of assessing of a level of implementation comprises:
generating of a questionnaire comprising at least one question for each of said requirements;
evaluating of replies provided to said at least one question by mapping said replies to a value within a predefined range; and
calculating of said level of implementation by use of said mapped value.

8. The method according to claim 1,
wherein the step of evaluating the resilience of said component against attacks comprises:
collecting and categorizing of said test cases by use of risk assessing results, obtained by assessing of risks, and by use of implementation level assessing results, obtained by assessing a level of implementation for each standardized security measure;
retrieving information on targets of said test cases;
analyzing of threats arising with regard to said targets of said test cases and determining of risks of said threats; and
performing of said test cases, wherein with each of said test cases targets of said test cases are accessed.

9. A computer program product comprising a computer readable medium storing computer executable program code which when executed on a computer performs the steps of:
assessing risks of said component and deriving security measures for said component;
assessing a level of implementation for each security measure, which is defined by at least one of a standard and a requirement document for said component; and
evaluating a resilience of said component against attacks directed to said component by performing test attacks against said component, said test attacks being arranged by use of test cases and by use of implementation level assessing results.

10. A computer program product according to claim 9, wherein the computer readable medium is a data carrier.

11. A system operable to assess a security of a component, comprising:
a risk assessment module, said risk assessment module being configured for assessing of risks of said component and deriving of security measures for said component;
a first assessment module, said first assessment module being configured for assessing a level of implementation for each security measure, which is defined by at least one of a standard and a requirement document for said component; and
a second assessment module, said second assessment module being configured for evaluating a resilience of said component against attacks directed to said component by performing test attacks against said component, said test attacks being arranged by use of test cases and by use of implementation level assessing results.

12. The system according to claim 11,
wherein said test cases are based on risk assessing results.

13. The system according to claim 11,
wherein results of assessing the level of implementation are obtained by assessing a level of implementation for each security measure.

14. The system according to claim 11, wherein said risk assessment module is operable to identify threats which arise with regard to said component, and to evaluate said threats, wherein for each threat a likelihood and an impact of the corresponding threat is determined.

15. The system according to claim 14,
wherein said risk assessment module is operable to calculate said risks by use of said identified and evaluated threats.

16. The system according to claim 11,
wherein said first assessment module is operable to use requirements defined in at least one of the standard and the requirement document for implementation of corresponding security measure, for which said level of implementation is assessed.

17. The system according to claim 16, wherein the the first assessment module is operable to:
generate a questionnaire comprising at least one question for each of said requirements;
evaluate replies provided to said at least one question by mapping said replies to a value within a predefined range; and
calculate said level of implementation by use of said mapped value.

18. The system according to claim 11,
wherein the second assessment module is operable to:
collect and categorize said test cases by use of risk assessing results, obtained by assessing of risks, and by use of implementation level assessing results, obtained by assessing a level of implementation for each standardized security measure;
retrieve information on targets of said test cases;
analyze threats arising with regard to said targets of said test cases and determine risks of said threats; and to
perform said test cases, wherein with each of said test cases targets of said test cases are accessed.

19. An apparatus for assessing a security of a component within an infrastructure,
said apparatus comprising:
means for assessing risks of said component and deriving security measures for said component;
means for assessing of a level of implementation for each security measure, which is defined by a standard and/or requirement document for said component; and
means for evaluating a resilience of said component against attacks directed to said component by performing test attacks against said component, said test attacks being arranged by use of test cases and by use of implementation level assessing results.
